(19) United States
(12) Patent Application Publication
(10) Pub. No.: US 2005/0001498 A1
(43) Pub. Date: Jan. 6, 2005

(54) Rotor of a permanent-magnet motor and corresponding manufacturing method

(76) Inventors: Reijo Kohonen, Espoo (FI); Juhani Hyvarinen, Espoo (FI); Ilkka T. Ikonen, Nummela (FI); Sami Wainio, Helsinki (FI); Matti Poyhonen, Mustasaari (FI); Juhani Moksy, Vaasa (FI); Jorma Rinta-Valkama, Vaasa (FI); Kimmo Forsman, Vaasa (FI); Bengt Ryholm, Vasteras (SE)

Correspondence Address: BIRCH STEWART KOLASCH & BIRCH, PO BOX 747, FALLS CHURCH, VA, 22040-0747, US

(21) Appl. No.: 10/497,209

(22) PCT Filed: Mar. 5, 2003
(86) PCT No.: PCT/FI03/00163

(30) Foreign Application Priority Data
Mar. 7, 2002 (FI) 200020438

(51) Int. Cl. H02K 15/03

(52) U.S. Cl. 310/156.08; 29/598

(57) ABSTRACT

A method for making a rotating part of plastic material for a permanent magnet motor and a rotor arranged on the outer circumference of the rotating part, said rotor comprising an annular pan (1) and a permanent magnet unit fitted around it, in which method the rotating part is cast in a mold tool (4). The annular part (1) together with the permanent magnets (2) is placed inside a plastic injection mold tool (4), said plastic injection mold tool (4) being divided radially into several sectors (4a-4d) which are provided with slots (6) allowing them to be moved radially by an actuator. When the plastic injection mold tool (4) is being closed, the sector are tightened radially inwards, specifically closing the air gap between the outer surface of the permanent magnet unit (2) and the sectors of the plastic injection mold tool (4), whereupon plastic injection molding is performed.

The present invention relates to a rotor for a permanent-magnet motor as defined in the preamble of claim 1, arranged on the outer circumference of the rotating part of the motor. The invention also relates to a manufacturing method.

In prior art, axial fans are known in which the rotor of an electric motor is integrated with the impeller, the fan and motor having a common frame and housing, so it is not necessary to provide separate bearings and axles for the fan and the motor. An axial fan of this type is disclosed e.g. in U.S. Pat. No. 4,618,806, which comprises a brushless direct-current motor in which an impeller and a rotor placed on its outer circumference are rotated by a stator. The rotor has an annular permanent magnet, which is magnetized in eight different segments. The permanent magnet is attached to a ring on the outer circumference of the impeller. As the rotor is arranged on the circumference of the impeller, the impeller bearing is not unduly heated by the heat generated by the electric motor, as it would be if the electric motor were mounted near the bearing. The placement of the rotor and stator on the circumference eliminates the fast wear caused by bearing currents. In addition, the bearing is thus potential-free.

A drawback with prior-art rotors of permanent magnet motors is a relatively complicated structure and a complicated manufacturing process.

It is an object of the invention to overcome the drawbacks of prior-art and to produce a new type of rotor arranged on the outer circumference of the rotating part of a motor. It is also an object of the invention to create a new type of method for manufacturing the rotating part of a motor and a rotor arranged on its outer circumference.

In the rotor of the invention for a permanent magnet motor, an inner ring made from band material, preferably dynamo sheet band is used, on the outside of which is arranged a permanent magnet part, either in segments that can be secured to the surface of the ring part or as a polarized magnet ring.

In the manufacturing method of the invention, a ring part is prepared from dynamo sheet band and a permanent magnet part is arranged on its outer circumference, either in segments that can be secured to the surface of the ring part or as a polarized magnet ring, and the rotor thus formed is tightened in a mould so that no plastic will be spread onto the magnets.

The features of the invention are specified in detail in the claims below.

The primary advantage of the invention is that a very simple structure is achieved that is additionally simple to manufacture. Moreover, by applying the invention, the rotor/impeller can be balanced in a simple and fast manner.

In the following, the invention will be described in detail with reference to an example and the attached drawings, wherein

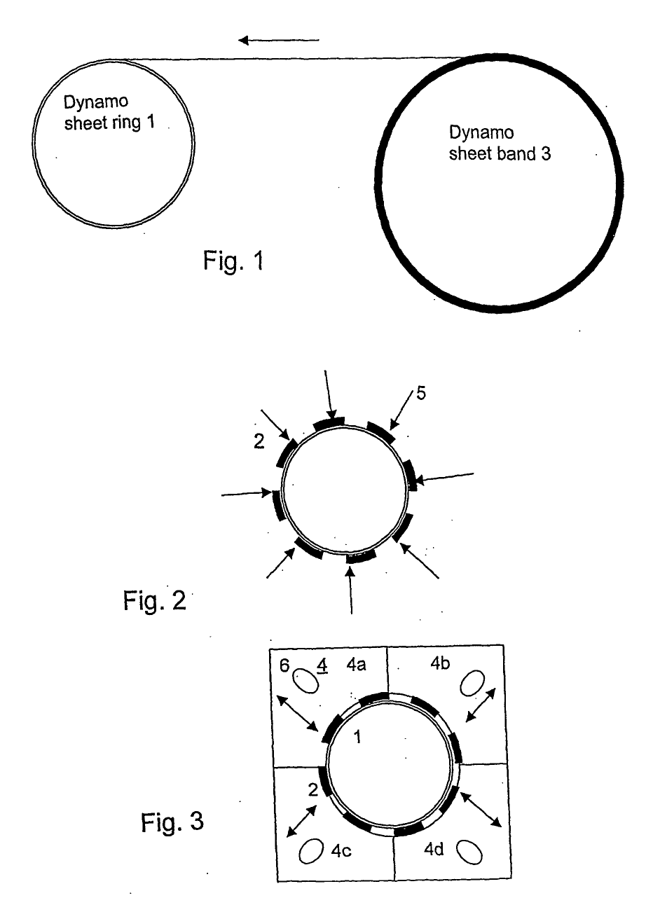

FIG. 1 illustrates how a dynamo sheet ring for a rotor arranged on the outer circumference of the rotating part of a permanent magnet motor is produced according to the invention,

FIG. 2 illustrates the gluing/fixing of permanent magnets,

FIG. 3 illustrates how a rotor arranged on the outer circumference of the rotating part of a permanent magnet motor is produced according to the invention by using a plastic injection mold tool, and

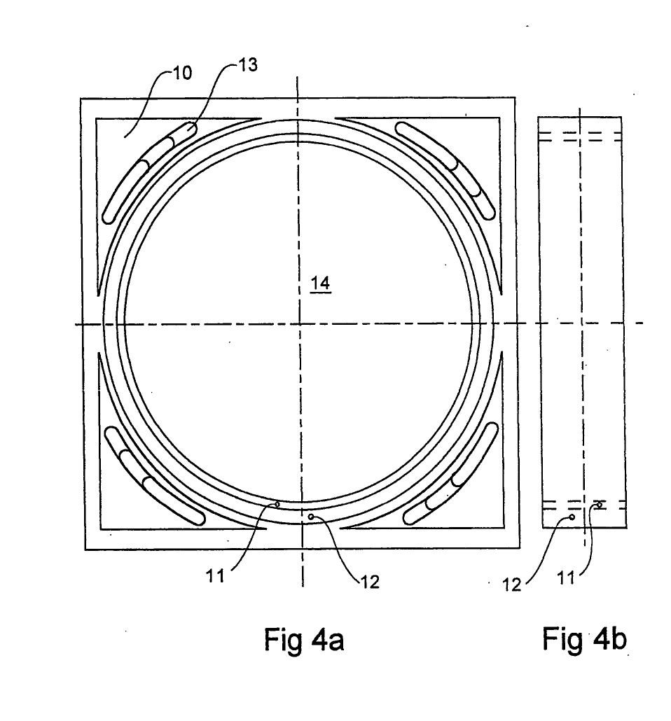

FIGS. 4a and 4b present a rotor structure according to the invention, comprising a multi-pole magnet ring, in front view and in side view.

FIGS. 1-3 illustrate an arrangement according to the invention for making a rotor for the permanent magnet motor of an axial fan for use e.g. in air conditioning systems. In the axial fan of the invention, the stator of the motor is mounted around the rotor and secured to the housing, and the rotor is integrated with the impeller. The fan has a plastic impeller comprising a rotor arranged on its outer circumference, a hole for a shaft at its center and impeller vanes arranged between the central part and an outer annular part.

In the invention, the rotor of the permanent magnet motor consists of a dynamo sheet ring 1 and permanent magnet segments 2. The dynamo sheet ring is made from dynamo sheet band 3, which is wound about to form a ring as illustrated in FIG. 1. The dynamo sheet ring 1 controls the direction of the magnetic flux. The permanent magnets 2 are glued to the outer surface of the dynamo sheet ring 1 as illustrated in FIG. 2. The body of the rotor/impeller is produced by the plastic injection molding method, e.g. in an automatically calibrated plastic injection mold tool 4.

In the invention, the dynamo sheet ring 1 is made from dynamo sheet band 3, which is wound to a desired thickness and welded/joined to form a solid ring. The permanent magnets 2 are glued/attached onto the dynamo sheet ring 1 in a jig in appropriate positions as indicated by the arrows 5. The dynamo sheet ring 1, together with the glued/attached permanent magnets 2 are placed in correct positions inside the plastic injection mold tool 4, which has inside it an opening 4e having a shape corresponding to the shape of the rotor/impeller. The plastic injection mold tool 4 is divided in the radial direction of the impeller into four sectors 4a-4d, which are provided with slots 6 allowing them to be moved by an actuator (not shown) in the radial direction of the shape of the impeller mold as indicated by the arrows. When the plastic injection mold tool 4 is opened, the four sectors are automatically moved radially outwards to allow the dynamo sheet ring to be inserted and the finished product to be removed. When the plastic injection mold tool 4 is to be closed, the four sectors are tightened radially inwards, thus closing the air gap between the outer surface of the permanent magnets 2 and the four radially moving sectors of the plastic injection mold tool 4. Plastic injection molding can then be carried out. When the sectors are being tightened, no plastic can be spread onto the permanent magnet segments.

The product is a plastic rotor/impeller which comprises a dynamo sheet ring 1 with permanent magnets 2 as integrated parts and in which the need for balancing as well as the air gap between the active rotor and stator components have been minimized.

The multi-pole magnet ring according to the invention may also be implemented as illustrated in FIGS. 4a and 4b. In this embodiment, the stator winding 13 is fitted in the fan frame 10 and the rotor/impeller 14 is fitted inside it, the rotor/impeller comprising a dynamo sheet ring 11 and around it a polarized magnet ring 12, in which the + and − poles are magnetized as required. Such a magnet ring is easy to fit into a mold. The inner ring 11 made from dynamo sheet band is automatically stretched inside the magnet ring 12. It can be easily placed in the mold.

The dynamo sheet need not be insulated or directed in the conventional manner, like e.g. transformer sheets.

It is obvious to the person skilled in the art that the embodiments of the invention are not limited to the example described above, but that they may instead be varied within the scope of the claims presented below.

1. Rotor arranged on the outer circumference of the rotating part (14) of a permanent magnet motor, said rotor comprising an annular part (1,11) and a permanent magnet unit fitted around it, characterized in that the annular part is made of band-like material.

2. Rotor according to claim 1, characterized in that the band-like material consists of dynamo sheet band, which forms a dynamo sheet ring.

3. Rotor according to claim 1, characterized in that the permanent magnet unit is a polarized magnet ring.

4. Method for making a rotating part (14) of plastic material for a permanent magnet motor and a rotor arranged on the outer circumference of the rotating part, said rotor comprising an annular part (1) and a permanent magnet unit fitted around it, in which method the rotating part is cast in a mold tool (4), characterized in that
the annular part (1) together with the permanent magnets (2) is placed inside a plastic injection mold tool (4), said plastic injection mold tool (4) being divided radially into several sectors (4a-4d) which are provided with slots (6) allowing them to be moved radially by an actuator,
and when the plastic injection mold tool (4) is being closed, the sectors are tightened radially inwards, specifically closing the air gap between the outer surface of the permanent magnet unit (2) and the sectors of the plastic injection mold tool (4),
whereupon plastic injection molding is performed.

5. Method according to claim 4, characterized in that the annular part is formed from band-like material, which is wound to a desired thickness and joined to form a solid ring.

6. Method according to claim 5, characterized in that the band-like material consists of dynamo sheet band, which forms a dynamo sheet ring.

7. Method according to claim 4, characterized in that the permanent magnet unit is a polarized magnet ring (12), and an inner ring (11) made of band material is automatically stretched inside the magnet ring (12).
